(19) United States
(12) Patent Application Publication
(10) Pub. No.: US 2012/0103008 A1
(43) Pub. Date: May 3, 2012

(54) HEATER UNIT AND AIR CONDITIONER INCLUDING THE SAME

(76) Inventors: Hwanjong Choi, Seoul (KR); Seunghyun Jung, Seoul (KR); Byoungjin Ryu, Seoul (KR)

(21) Appl. No.: 13/382,734

(22) PCT Filed: Mar. 18, 2010
(86) PCT No.: PCT/KR2010/001669

§ 371 Date: Jan. 6, 2012

(30) Foreign Application Priority Data
Sep. 15, 2009 (KR) 10-2009-0087124

(51) Int. Cl. F25B 21/00; H05B 6/02

(52) U.S. Cl. 62/513; 219/600

(57) ABSTRACT

Provided is a heater unit, which includes a heater-mounting part, a coil, a magnetic member, a cover member, and a coupling member. The heater-mounting part is attached to an outside of an object. The coil is coupled to the heater-mounting part and generates a magnetic field by electric current flowing therein. The magnetic member is disposed at a side of the coil, and is coupled to the heater-mounting part. The cover member covers an outside of the coil and an outside of the magnetic member. The coupling member detachably couples the heater-mounting part to the object. The heater unit is modularized so as to be removably mounted on the air conditioner, whereby the coil can be efficiently replaced and repaired.

### BACKGROUND

The present disclosure relates to a heater unit and an air conditioner including the heater unit.

Air conditioners maintain indoor air in an optimized condition according to its purpose. For example, the indoor air may be cooled in summer, and be heated in winter, and indoor humidity may be controlled to adjust the indoor air to a comfortable state.

As home appliances such as air conditioners are widely used, they are required to have high energy efficiency, high performances, and convenience.

Such air conditioners are classified into separate-type air conditioners in which an indoor unit is separated from an outdoor unit, and integrated air conditioners in which an indoor unit and an outdoor unit are integrated. In addition, air conditioners may be classified into wall-mounted type and picture frame type air conditioners that are mounted on a wall, and slim type air conditioners that stand up on a floor, according to installation methods.

The separate-type air conditioners include an indoor unit for supplying warm or cool air to an indoor space, and an outdoor unit for compressing of expanding refrigerant for sufficient heat exchange within the indoor unit.

When an air conditioner capable of performing both cooling and heating operations is in the heating operation, a temperature sensor of an outdoor heat exchanger may sense frost on the outdoor heat exchanger. At this point, an inverter compressor may be induced to low frequency to switch a four-way valve and then temporarily perform a cooling cycle, thereby defrosting the outdoor heat exchanger.

However, in this case, an indoor heat exchanger functions as an evaporator, and a defrosting operation is performed in a cooling state, and thus, indoor temperature is decreased.

In addition, when the air conditioner is switched to the cooling operation, a certain time period is required until high temperature refrigerant is supplied to the outdoor heat exchanger, and thus, a time period required to defrost the outdoor heat exchanger is increased.

### SUMMARY

Embodiments provide a heater unit and an air conditioner including the heater unit, in which a heater module provided to the air conditioner has an improved structure to be easily and removably coupled to the air conditioner.

Embodiments also provide a heater unit flexibly and removably attached to targets having various sizes, and an air conditioner including the heater unit.

In one embodiment, a heater unit includes: a heater-mounting part attached to an outside of an object; a coil coupled to the heater-mounting part and generating a magnetic field by electric current flowing therein; a magnetic member disposed at a side of the coil and coupled to the heater-mounting part; a cover member covering an outside of the coil and an outside of the magnetic member; and a coupling member for detachably coupling the heater-mounting part to the object.

In another embodiment, an air conditioner includes: a compressor for compressing refrigerant; an indoor heat exchanger where the refrigerant discharged from the compressor exchanges heat with indoor air; an expansion device for depressurizing the refrigerant discharged from the indoor heat exchanger; an outdoor heat exchanger where the refrigerant discharged from the expansion device exchanges heat with outdoor air; a gas/liquid separator provided to an outlet of the outdoor heat exchanger or an inlet of the compressor, and separating liquid refrigerant from the refrigerant; and a heater unit provided to the gas/liquid separator, wherein the heater unit includes: a first assembly at a side of the gas/liquid separator; a second assembly at another side of the gas/liquid separator; and a coupling member removably coupling the first and second assemblies to the gas/liquid separator.

In another embodiment, an air conditioner including a compressor, an indoor heat exchanger, an expansion device, and an outdoor heat exchanger to perform a refrigerating cycle includes: a gas/liquid separator for separating liquid refrigerant from refrigerant introduced from the outdoor heat exchanger to the compressor; a heater-mounting part removably coupled to an outer surface of the gas/liquid separator; an induction heater coupled to the heater-mounting part; a cover member covering the induction heater; and a coupling member surrounding the heater-mounting part to fix the heater-mounting part to the gas/liquid separator.

The details of one or more embodiments are set forth in the accompanying drawings and the description below. Other features will be apparent from the description and drawings, and from the claims.

### BRIEF DESCRIPTION OF THE DRAWINGS

FIG. 1 is a schematic view illustrating a configuration of a heating cycle of an air conditioner according to an embodiment.

FIG. 2 is a perspective view illustrating a state in which a heat unit is mounted on a gas/liquid separator, according to an embodiment.

FIG. 3 is an exploded perspective view illustrating the heater unit mounted on the gas/liquid separator of FIG. 2.

FIG. 4 is a perspective view illustrating a configuration of a heater-mounting part according to a current embodiment.

FIG. 5 is a cross-sectional view taken along line I-I′ of FIG. 2.

### DETAILED DESCRIPTION OF THE EMBODIMENTS

Reference will now be made in detail to the embodiments of the present disclosure, examples of which are illustrated in the accompanying drawings.

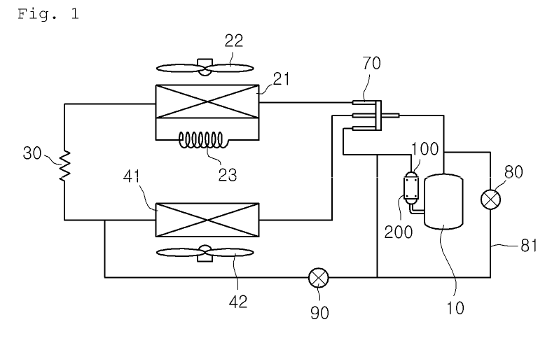

FIG. 1 is a schematic view illustrating a configuration of a heating cycle of an air conditioner according to an embodiment.

Referring to FIG. 1, an air conditioner 1 according to the current embodiment includes a compressor 10 for compressing refrigerant, an indoor heat exchanger 21 to which the refrigerant compressed to a high temperature and high pressure state by the compressor 10 is introduced to exchange heat with indoor air, an indoor fan 22 for blowing heat-exchanged warm air to an indoor space; a capillary 30 as an expansion device for expanding the heat-exchanged refrigerant to low pressure, an outdoor heat exchanger 41 where the expanded refrigerant exchanges heat with outdoor air and an outdoor fan 42 for blowing heat-exchanged cold air to an outdoor space.

When the air conditioner 1 performs a heating cycle, the indoor heat exchanger 21 functions as a condenser where the refrigerant compressed by the compressor 10 is condensed to a low temperature state, and the outdoor heat exchanger 41 functions as an evaporator where the refrigerant depressurized in a liquid state by the capillary 30 is evaporated.

The refrigerant circulating through the heating cycle is in a high pressure state before the capillary 30, and is in a low pressure state after the capillary 30. Hereinafter, the refrigerator before the capillary 30 is referred to as high pressure refrigerant, and the refrigerator after the capillary 30 is referred to as low pressure refrigerant.

An indoor heat exchanger heater 23 is disposed at a side of the indoor heat exchanger 21. When an outdoor temperature is low, the indoor heat exchanger heater 23 may supplement insufficient heating capacity of the indoor heat exchanger 21 in a refrigerating cycle.

During a continuous heating defrosting operation, conditioned air discharged to the indoor space can be maintained at a certain temperature or higher by the indoor heat exchanger heater 23.

During a continuous heating defrosting operation, a heating operation is performed simultaneously with a defrosting operation on the outdoor heat exchanger 41. The defrosting operation may be performed on the outdoor heat exchanger 41 by discharging the refrigerant in the high temperature and high pressure state from the compressor 10 to an inlet of the outdoor heat exchanger 41 through a bypass.

The outlet of the outdoor heat exchanger 41 is provided with a gas/liquid separator 100 that separates liquid refrigerant from the refrigerant evaporated by the outdoor heat exchanger 41, to introduce only gas refrigerant to the compressor 10.

The air conditioner 1 is provided with a bypass passage 81 through which refrigerant hot gas discharged from the compressor 10 is introduced at least to the inlet of the outdoor heat exchanger 41 or to an inlet of the gas/liquid separator 100. That is, the bypass passage 81 extends from the outlet of the compressor 10 to the inlet of the outdoor heat exchanger 41 and the inlet of the compressor 10.

The bypass passage 81 is provided with a first valve 80 that adjusts the flow rate of refrigerant flowing through the bypass passage 81. The first valve 80 may include a solenoid valve.

The refrigerant discharged from the compressor 10 flows to the inlet of the compressor 10 through the bypass passage 81, to thereby increase the evaporation temperature and pressure of the refrigerant at the inlet of the compressor 10. Accordingly, input work (load) of the compressor 10 can be decreased. In addition, the capacity of the compressor 10 and the capacity of the indoor heat exchanger 21 are balanced, to thereby improve heating efficiency.

The refrigerant in the high temperature and high pressure state discharged from the compressor 10 is introduced to the inlet of the outdoor heat exchanger 41 through the bypass passage 81, thereby defrosting the outdoor heat exchanger 41.

That is, the first valve 80 introduces the refrigerant to the bypass passage 81, so that the continuous heating defrosting operation can be performed.

The bypass passage 81 is provided with a second valve 90 that prevents refrigerant from flowing from the inlet of the outdoor heat exchanger 41 to the inlet of the gas/liquid separator 100.

In a normal heating mode, the second valve 90 may prevent refrigerant from flowing backward to the inlet of the gas/liquid separator 100 from the inlet of the outdoor heat exchanger 41 through the bypass passage 81. The second valve 90 may include a check valve.

The outlet of the compressor 10 is provided with a four-way valve 70 that switches the flow direction of refrigerant according to a cooling mode or a heating mode of the air conditioner 1.

In the heating mode, the refrigerant discharged from the outdoor heat exchanger 41 is introduced to the compressor 10 through the four-way valve 70, and is compressed, and the compressed refrigerant is introduced to the indoor heat exchanger 21 through the four-way valve 70.

On the contrary, in the cooling mode, the refrigerant discharged from the indoor heat exchanger 21 is introduced to the compressor 10 through the four-way valve 70, and is compressed, and the compressed refrigerant is introduced to the outdoor heat exchanger 41 through the four-way valve 70.

A heater unit 200 is disposed on the outer portion of the gas/liquid separator 100 to heat the refrigerant in the gas/liquid separator 100. The heater unit 200 may surround at least one portion of the outer circumferential surface of the gas/liquid separator 100. Hereinafter, a configuration of the heater unit 200 will now be described with reference to the accompanying drawings.

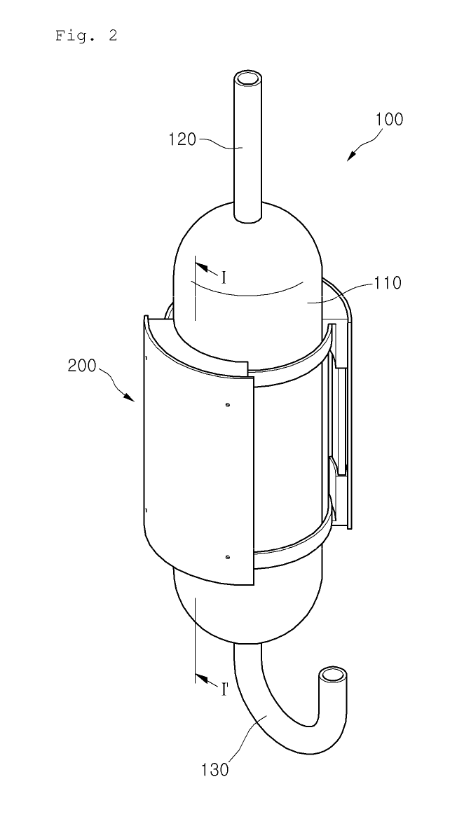

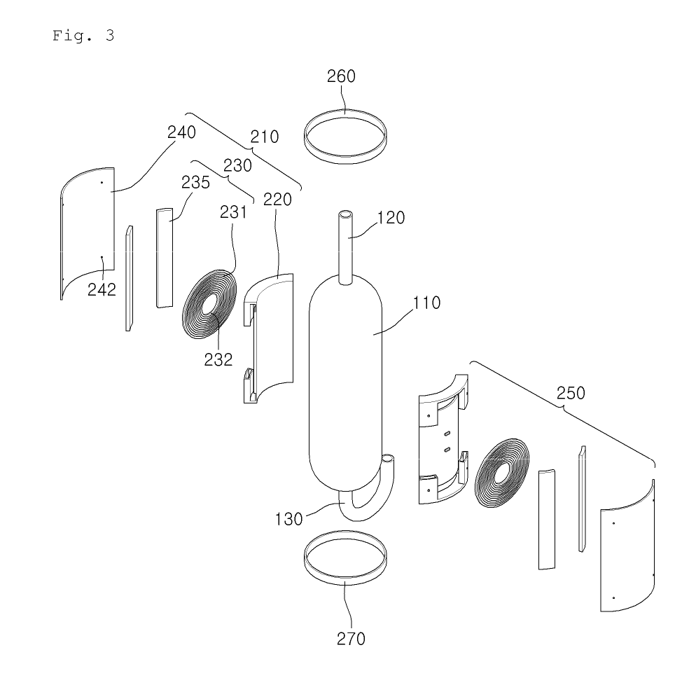

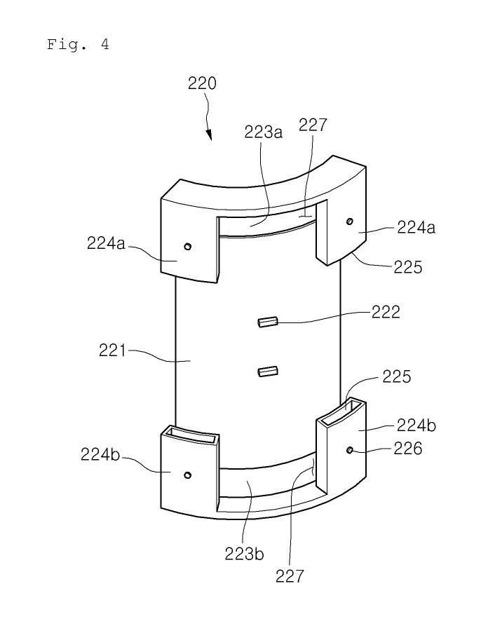

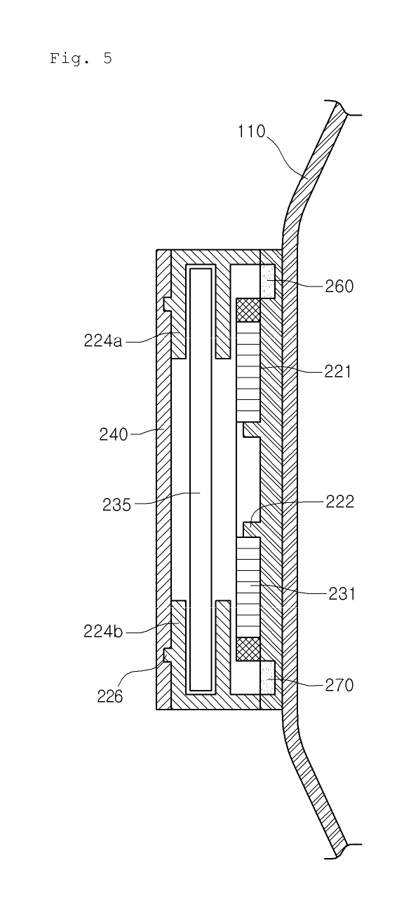

FIG. 2 is a perspective view illustrating a state in which a heat unit is mounted on a gas/liquid separator, according to an embodiment. FIG. 3 is an exploded perspective view illustrating the heater unit mounted on the gas/liquid separator of FIG. 2. FIG. 4 is a perspective view illustrating a configuration of a heater-mounting part according to the current embodiment. FIG. 5 is a cross-sectional view taken along line I-I′ of FIG. 2.

Referring to FIGS. 2 to 5, the gas/liquid separator 100 includes a body 110 constituting the appearance thereof, an intake pipe 120 disposed at a side of the body 110 and receiving gas/liquid mixed refrigerant, and a discharge pipe 130 disposed at another side of the body 110 and discharging gas refrigerant separated from liquid refrigerant.

The heater unit 200 is disposed outside the body 110 to provide a certain amount of heat to the gas/liquid separator 100.

Although the heater unit 200 is attached to the outer portion of the gas/liquid separator 100 in the current embodiment, the heater unit 200 may be attached to other part than the gas/liquid separator 100. For example, the heater unit 200 may be attached to an oil separator for separating oil discharged from the compressor 10.

The heater unit 200 includes a first assembly 210 disposed at a side of the outer surface of the body 110, a second assembly 250 disposed at another side of the outer surface of the body 110, and first and second coupling members 260 and 270 for coupling the first and second assemblies 210 and 250 to the gas/liquid separator 100.

The first and second assemblies 210 and 250, constitute a module for efficiently and removably coupling the heater unit 200 to the gas/liquid separator 100, are the same in configuration, and thus, a description thereof will now be made with respect to the first assembly 210.

The first assembly 210 includes a heater-mounting part 220 coupled to the outer surface of the body 110, an induction heater 230 coupled to a side of the heater-mounting part 220 to generate a certain amount of heat, and a cover member 240 disposed outside the induction heater 230.

The induction heater 230 includes a coil 231 through which electric current flows, and a plurality of magnetic members 235 disposed at a side of the coil 231 and having certain magnetic properties.

The heater-mounting part 220 includes a coil-mounting surface 221 on which the coil 231 is mounted. The inner surface of the coil-mounting surface 221 contacts the outer surface of the body 110, and may be rounded with a certain curvature to correspond to the outer surface of the body 110.

The heater-mounting part 220 includes a catching protrusion 222 that is disposed at a side of the coil-mounting surface 221 to catch the coil 231. The catching protrusion 222 may be provided in plurality.

The coil 231 has a donut shape having an inner through portion. The inner circumferential surface of the coil 231 is provided with a catching part 232 caught by the catching protrusion 222. The catching part 232 constitutes the inner circumferential surface of the coil 231, and may be provided in plurality to correspond to the catching protrusions 222.

The induction heater 230 will now be described.

The induction heater 230 uses, as a heat source, induced current generated by a magnetic field. Alternating current (AC) flows through the coil 231 to generate a magnetic field. An AC magnetic field generated by the coil 231 passes through the magnetic members 235.

Magnetic flux from the AC magnetic field passes through the gas/liquid separator 100. Accordingly, induced current is generated by electromagnetic induction. The induced current generates a certain amount of heat.

In the continuous heating defrosting operation, the induction heater 230 heats the low pressure refrigerant, that is, the refrigerant at the outdoor heat exchanger 41 to increase the evaporation temperature of the refrigerant and remove frost from the outdoor heat exchanger 41.

Furthermore, the induction heater 230 may heat the high pressure refrigerant, that is, the refrigerant at the indoor heat exchanger 21 to increase the condensation temperature of the refrigerant. As such, the induction heater 230 increases the evaporation temperature of the refrigerant and the condensation temperature of the refrigerant, thereby improving the heating efficiency and defrosting efficiency.

Furthermore, the induction heater 230 heats the indoor heat exchanger 21 in the normal heating mode to increase a pipe temperature of the indoor heat exchanger 21, thereby quickly heating air discharged to the indoor space.

An amount of heat supplied from the induction heater 230 may be adjusted using an inverter method. In this case, the amount of supplied heat may be varied according to outdoor temperature and the temperature of a heat exchanger requiring defrosting.

The heater-mounting part 220 includes magnetic member coupling parts 224a and 224b to which the magnetic members 235 are coupled.

The magnetic member coupling parts 224a and 224b include a plurality of first magnetic member coupling parts 224a at the upper side of the coil-mounting surface 221, and a plurality of second magnetic member coupling parts 224b at the lower side of the coil-mounting surface 221.

The magnetic member coupling parts 224a and 224b are externally spaced apart from the coil-mounting surface 221.

The first and second magnetic member coupling parts 224a and 224b are provided with insertion recesses 225, respectively, in which the magnetic members 235 are inserted. The magnetic members 235 are inserted into the insertion recesses 225 of the first and second magnetic member coupling parts 224a and 224b, and thus, are coupled to the heater-mounting part 220.

The first and second magnetic member coupling parts 224a and 224b are provided with coupling protrusions 226, respectively, to which the cover member 240 are coupled. The coupling protrusions 226 protrude externally from the first and second magnetic member coupling parts 224a and 224b.

The cover member 240 includes receiving recesses 242 to receive the coupling protrusions 226. The receiving recesses 242 are located in positions corresponding to the coupling protrusions 226, and are disposed in the inner surface of the cover member 240.

The coupling protrusions 226 are inserted in the receiving recesses 242, so that the heater-mounting part 220 can be easily coupled to the cover member 240.

When the cover member 240 is mounted on the heater-mounting part 220, the magnetic members 235 may be disposed between the coil 231 and the cover member 240.

A mounting space 227 in which the first and second coupling members 260 and 270 are disposed is disposed between the coil-mounting surface 221 and the first and second magnetic member coupling parts 224a and 224b. The first and second coupling members 260 and 270 have an approximately ring shape, and are fitted in the mounting space 227.

The first coupling member 260 is disposed in a mounting space 227 (hereinafter, referred to as a first space) between the coil-mounting surface 221 and the first magnetic member coupling parts 224a. The second coupling member 270 is disposed in a mounting space 227 (hereinafter, referred to as a second space) between the coil-mounting surface 221 and the second magnetic member coupling parts 224b.

A first coupling part 223a to which the first coupling member 260 is coupled is disposed over the coil-mounting surface 221. A second coupling part 223b to which the second coupling member 270 is coupled is disposed under the coil-mounting surface 221.

To sum up, the first and second coupling members 260 and 270 surround the first and second assemblies 210 and 250, particularly, the heater-mounting part 220 to fix the first and second assemblies 210 and 250 to the gas/liquid separator 100.

The first and second coupling members 260 and 270 may include a cable tie or a belt member, and may be cut when the first and second assemblies 210 and 250 are replaced or repaired.

That is, the first and second coupling members 260 and 270 can fix the first and second assemblies 210 and 250, particularly, the heater-mounting part 220 to the gas/liquid separator 100. When the first and second assemblies 210 and 250 are removed from the gas/liquid separator 100, the first and second coupling members 260 and 270 may be cut off.

As such, the heater unit 200 can be easily and removably coupled to the gas/liquid separator 100 by the first and second coupling members 260 and 270. Thus, welding or a separate structure for coupling the heater unit 200 is unnecessary.

A silicon sheet may be provided to the heater-mounting part 220. The silicon sheet has insulation properties and fire retardancy to prevent a fire or accident while the induction heater 230 generates heat.

Since the silicon sheet can have a desired shape through injection molding, and is flexible, the size of the silicon sheet may be varied with the size of the gas/liquid separator 100.

The magnetic members 235 may include a ferrite material. The ferrite material is ferromagnetic, and forms a weak magnetic field. Also, the ferrite material has strong magnetic permeability to enhance magnetic induction of the induction heater 230, and has insulation properties.

The coil 231 provided to the first assembly 210 may be electrically connected (in series) to a coil provided to the second assembly 250 in order to generate heat. Accordingly, heat can be uniformly transferred to the gas/liquid separator 100.

The cover member 240 is disposed outside the magnetic members 235 to cover components of the heater unit 200.

To sum up, the heater unit 200 includes the first and second assemblies 210 and 250 that are electrically connected to each other to efficiently heat the gas/liquid separator 100.

Since the first and second assemblies 210 and 250 are removably attached to the outer surface of the gas/liquid separator 100, the heater unit 200 can be efficiently replaced or repaired.

Since the heater-mounting part 220 includes the silicon sheet, the heater-mounting part 220 can have a desired shape through injection molding. In addition, since the heater-mounting part 220 is flexible, the heater-mounting part 220 can be applied to gas/liquid separators having various sizes.

Since the heater-mounting part 220 has insulation properties and fire retardancy, current is prevented from flowing through the gas/liquid separator 100, and the possibility of a fire due to heating of the heater unit 200 is reduced.

According to the embodiments, a continuous heating defrosting operation in which a heating operation and a defrosting operation are simultaneously performed improves indoor heating performance, and defrosts an outdoor heat exchanger.

In addition, a heater unit is modularized so as to be removably mounted on an air conditioner, whereby a coil of the heater unit can be efficiently replaced and repaired.

In addition, a silicon sheet provided to the heat unit can be applied to gas/liquid separators having various sizes, and has insulation properties and fire retardancy so as to stably support the heater.

The silicon sheet can have a desired shape through injection molding, and thus, the shape thereof can be varied according to the shape of an object attached to the heater.

In addition, an induction heater is provided to an accumulator to reduce heat loss to outdoor air, and time required for transferring heat from the induction heater to refrigerant can be reduced.

In addition, since heat is transferred from the induction heater to low pressure refrigerant in a heating cycle during a heating operation, heating performance can be increased without additionally increasing the output of a compressor.

In addition, while an evaporator is defrosted, the induction heater is operated to further increase the amount of heat transferred to the low pressure refrigerant, thus improving defrosting performance of the air conditioner.

According to the embodiment, a heater unit is modularized so as to be removably mounted on an air conditioner, whereby a coil of the heater unit can be efficiently replaced and repaired. Thus, the embodiment is industrially applicable.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A heater unit comprising:
a heater-mounting part attached to an outside of an object;
a coil coupled to the heater-mounting part and generating a magnetic field by electric current flowing therein;
a magnetic member disposed at a side of the coil and coupled to the heater-mounting part;
a cover member covering an outside of the coil and an outside of the magnetic member; and
a coupling member for detachably coupling the heater-mounting part to the object.

2. The heater unit according to claim 1, wherein the heater-mounting part is provided with at least one catching protrusion catching the coil, and
the coil is provided with a catching part corresponding to the catching protrusion.

3. The heater unit according to claim 1, wherein upper and lower portions of the heater-mounting part are provided with magnetic member coupling parts that has insertion recesses to which the magnetic member is coupled.

4. The heater unit according to claim 1, further comprising:
a coupling protrusion provided to the heater-mounting part and coupled to the cover member; and
a receiving recess provided to the cover member and receiving the coupling protrusion.

5. The heater unit according to claim 1, wherein the coupling member comprises:
a first coupling member surrounding an upper portion of the heater-mounting part; and
a second coupling member surrounding a lower portion of the heater-mounting part.

6. The heater unit according to claim 1, wherein the coupling member comprises a cable tie or a belt member.

7. The heater unit according to claim 1, wherein the heater-mounting part comprises:
a coil-mounting surface on which the coil is mounted;
a magnetic member coupling part at a side of the coil-mounting surface; and
a mounting space between the coil-mounting surface and the magnetic member coupling part, and receiving the coupling member.

8. The heater unit according to claim 1, wherein the heater-mounting part comprises a silicon sheet that is proper for injection molding.

9. The heater unit according to claim 1, wherein the heater-mounting part is provided in plurality, and
the coupling member simultaneously couples a plurality of heater-mounting parts to the object.

10. The heater unit according to claim 1, wherein the heater unit is provided to an air conditioner comprising a compressor, an indoor heat exchanger, an expansion device, and an outdoor heat exchanger, and
the object comprises at least one of a gas/liquid separator for separating liquid refrigerant from refrigerant evaporated through the outdoor heat exchanger and an oil separator for separating oil discharged from the compressor.

11. An air conditioner comprising:
a compressor for compressing refrigerant;
an indoor heat exchanger where the refrigerant discharged from the compressor exchanges heat with indoor air;
an expansion device for depressurizing the refrigerant discharged from the indoor heat exchanger;
an outdoor heat exchanger where the refrigerant discharged from the expansion device exchanges heat with outdoor air;
a gas/liquid separator provided to an outlet of the outdoor heat exchanger or an inlet of the compressor, and separating liquid refrigerant from the refrigerant; and
a heater unit provided to the gas/liquid separator,
wherein the heater unit comprises:
a first assembly at a side of the gas/liquid separator;
a second assembly at another side of the gas/liquid separator; and
a coupling member removably coupling at least one of the first and second assemblies to the gas/liquid separator.

12. The air conditioner according to claim 11, wherein each of the first and second assemblies comprises:
an induction heater for generating heat by induction current;
a heater-mounting part on which the induction heater is mounted; and
a cover member covering an outside of the heater-mounting part.

13. The air conditioner according to claim 12, wherein the heater-mounting part is formed of a flexible material to have a preset curvature corresponding to an outer surface of the gas/liquid separator, and a variable size.

14. The air conditioner according to claim 12, wherein the induction heater comprises:
a coil generating a magnetic field by alternating current flowing therein; and
a magnetic member in a space between the coil and the cove member.

15. The air conditioner according to claim 11, wherein the coupling member is provided in plurality to surround an upper portion and a lower portion of the gas/liquid separator.

16. An air conditioner including a compressor, an indoor heat exchanger, an expansion device, and an outdoor heat exchanger to perform a refrigerating cycle, the air conditioner comprising:
a gas/liquid separator for separating liquid refrigerant from refrigerant introduced from the outdoor heat exchanger to the compressor;
a heater-mounting part removably coupled to an outer surface of the gas/liquid separator;
an induction heater coupled to the heater-mounting part;
a cover member covering the induction heater; and
a coupling member surrounding the heater-mounting part to fix the heater-mounting part to the gas/liquid separator.

17. The air conditioner according to claim 16, wherein the induction heater comprises:
a coil caught by the heater-mounting part; and
a magnetic member disposed at a side of the coil and inserted in the heater-mounting part.

18. The air conditioner according to claim 16, wherein the refrigerating cycle is performed using a continuous heating defrosting method in which a heating operation on an indoor space and a defrosting operation on the outdoor heat exchanger are simultaneously performed, and
the induction heater heats the refrigerant flowing through the outdoor heat exchanger.
